(19) United States
(12) Patent Application Publication
(10) Pub. No.: US 2019/0164107 A1
(43) Pub. Date: May 30, 2019

(54) AUTOMATED DISTRIBUTED SCREENING OF JOB CANDIDATES

(71) Applicant: Microsoft Technology Licensing, LLC, Redmond, WA (US)

(72) Inventors: Yogesh M. Upadhyay, Milpitas, CA (US); Bo Xing, Fremont, CA (US)

(73) Assignee: Microsoft Technology Licensing, LLC, Redmond, WA (US)

(21) Appl. No.: 15/827,353

(22) Filed: Nov. 30, 2017

(51) Int. Cl. G06Q 10/06; G06Q 10/10

(52) U.S. Cl. CPC G06Q 10/063112; G06Q 10/109; G06Q 10/06398; G06Q 10/1053

(57) ABSTRACT

The disclosed embodiments provide a system for processing data. During operation, the system obtains a set of interview attributes associated with an interview request, wherein the set of interview attributes comprises a skill set for a job, a timeline, and a budget. The system also obtains a set of interviewer attributes for a set of interviewers, wherein the set of interviewer attributes comprises a level of expertise in a skill. Next, the system uses the set of interview attributes and the set of interviewer attributes to identify a subset of the interviewers as matches for the interview request. The system then schedules a job interview between an interviewer in the subset of interviewers and a candidate for the job. At a conclusion of the job interview, the system obtains feedback for the job interview from the interviewer and the candidate.

### BACKGROUND

### Field

The disclosed embodiments relate to screening of job candidates. More specifically, the disclosed embodiments relate to techniques for performing automated distributed screening of job candidates.

### Related Art

Online networks may include nodes representing entities such as individuals and/or organizations, along with links between pairs of nodes that represent different types and/or levels of social familiarity between the entities represented by the nodes. For example, two nodes in an online network may be connected as friends, acquaintances, family members, and/or professional contacts. Online networks may further be tracked and/or maintained on web-based networking services, such as online professional networks that allow the entities to establish and maintain professional connections, list work and community experience, endorse and/or recommend one another, run advertising and marketing campaigns, promote products and/or services, and/or search and apply for jobs.

In turn, users and/or data in online professional networks may facilitate other types of activities and operations. For example, professionals may use an online professional network to locate prospects, maintain a professional image, establish and maintain relationships, and/or engage with other individuals and organizations. Similarly, recruiters may use the online professional network to search for candidates for job opportunities and/or open positions. At the same time, job seekers may use the online professional network to enhance their professional reputations, conduct job searches, reach out to connections for job opportunities, and apply to job listings. Consequently, use of online professional networks may be increased by improving the data and features that can be accessed through the online professional networks.

### BRIEF DESCRIPTION OF THE FIGURES

FIG. 1 shows a schematic of a system in accordance with the disclosed embodiments.

FIG. 2 shows a system for processing data in accordance with the disclosed embodiments.

FIG. 3 shows the automated distributed screening of a job candidate in accordance with the disclosed embodiments.

FIG. 4 shows a flowchart illustrating the processing of data in accordance with the disclosed embodiments.

FIG. 5 shows a computer system in accordance with the disclosed embodiments.

In the figures, like reference numerals refer to the same figure elements.

### DETAILED DESCRIPTION

The following description is presented to enable any person skilled in the art to make and use the embodiments, and is provided in the context of a particular application and its requirements. Various modifications to the disclosed embodiments will be readily apparent to those skilled in the art, and the general principles defined herein may be applied to other embodiments and applications without departing from the spirit and scope of the present disclosure. Thus, the present invention is not limited to the embodiments shown, but is to be accorded the widest scope consistent with the principles and features disclosed herein.

The data structures and code described in this detailed description are typically stored on a computer-readable storage medium, which may be any device or medium that can store code and/or data for use by a computer system. The computer-readable storage medium includes, but is not limited to, volatile memory, non-volatile memory, magnetic and optical storage devices such as disk drives, magnetic tape, CDs (compact discs), DVDs (digital versatile discs or digital video discs), or other media capable of storing code and/or data now known or later developed.

The methods and processes described in the detailed description section can be embodied as code and/or data, which can be stored in a computer-readable storage medium as described above. When a computer system reads and executes the code and/or data stored on the computer-readable storage medium, the computer system performs the methods and processes embodied as data structures and code and stored within the computer-readable storage medium.

Furthermore, methods and processes described herein can be included in hardware modules or apparatus. These modules or apparatus may include, but are not limited to, an application-specific integrated circuit (ASIC) chip, a field-programmable gate array (FPGA), a dedicated or shared processor that executes a particular software module or a piece of code at a particular time, and/or other programmable-logic devices now known or later developed. When the hardware modules or apparatus are activated, they perform the methods and processes included within them.

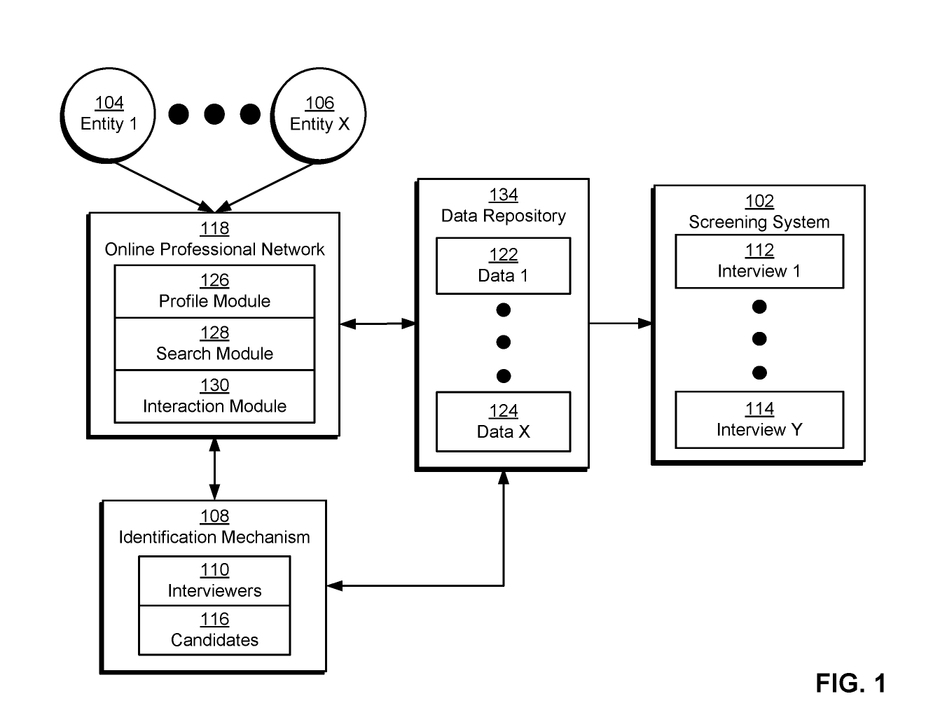

The disclosed embodiments provide a method and system for performing automated distributed screening of job candidates. As shown in FIG. 1, screening or interviewing or candidates may involve members of a social network or other community, such as an online professional network 118 that allows a set of entities (e.g., entity 1 104, entity x 106) to interact with one another in a professional and/or business context.

The entities may include users that use online professional network 118 to establish and maintain professional connections, list work and community experience, endorse and/or recommend one another, search and apply for jobs, and/or perform other actions. The entities may also include companies, employers, and/or recruiters that use online professional network 118 to list jobs, search for potential candidates, provide business-related updates to users, advertise, and/or take other action.

More specifically, online professional network 118 includes a profile module 126 that allows the entities to create and edit profiles containing information related to the entities' professional and/or industry backgrounds, experiences, summaries, job titles, projects, skills, and so on. Profile module 126 may also allow the entities to view the profiles of other entities in online professional network 118.

Profile module 126 may also include mechanisms for assisting the entities with profile completion. For example, profile module 126 may suggest industries, skills, companies, schools, publications, patents, certifications, and/or other types of attributes to the entities as potential additions to the entities' profiles. The suggestions may be based on predictions of missing fields, such as predicting an entity's industry based on other information in the entity's profile. The suggestions may also be used to correct existing fields, such as correcting the spelling of a company name in the profile. The suggestions may further be used to clarify existing attributes, such as changing the entity's title of “manager” to “engineering manager” based on the entity's work experience.

Online professional network 118 also includes a search module 128 that allows the entities to search online professional network 118 for people, companies, jobs, and/or other job- or business-related information. For example, the entities may input one or more keywords into a search bar to find profiles, job postings, articles, and/or other information that includes and/or otherwise matches the keyword(s). The entities may additionally use an “Advanced Search” feature in online professional network 118 to search for profiles, jobs, and/or information by categories such as first name, last name, title, company, school, location, interests, relationship, skills, industry, groups, salary, experience level, etc.

Online professional network 118 further includes an interaction module 130 that allows the entities to interact with one another on online professional network 118. For example, interaction module 130 may allow an entity to add other entities as connections, follow other entities, send and receive emails or messages with other entities, join groups, and/or interact with (e.g., create, share, re-share, like, and/or comment on) posts from other entities.

Those skilled in the art will appreciate that online professional network 118 may include other components and/or modules. For example, online professional network 118 may include a homepage, landing page, and/or content feed that provides the latest posts, articles, and/or updates from the entities' connections and/or groups to the entities. Similarly, online professional network 118 may include features or mechanisms for recommending connections, job postings, articles, and/or groups to the entities.

In one or more embodiments, data (e.g., data 1 122, data x 124) related to the entities' profiles and activities on online professional network 118 is aggregated into a data repository 134 for subsequent retrieval and use. For example, each profile update, profile view, connection, follow, post, comment, like, share, search, click, message, interaction with a group, address book interaction, response to a recommendation, purchase, and/or other action performed by an entity in online professional network 118 may be tracked and stored in a database, data warehouse, cloud storage, and/or other data-storage mechanism providing data repository 134.

In turn, member profiles and/or activity with online professional network 118 are used by a screening system 102 to automatically schedule, track, and/or manage interviews (e.g., interview 1 112, interview y 114) for jobs, positions, roles, and/or opportunities that are listed within or outside online professional network 118. For example, screening system 102 may be used by recruiters, managers, human resources professionals, and/or other “moderators” involved in filling the jobs, positions, roles, and/or opportunities to manage, schedule, and/or track phone screen interviews, onsite interviews, auditions, and/or other types of interviews or interaction related to screening candidates 116 for the jobs, positions, roles, and/or opportunities. Because screening system 102 is coupled to and/or included in online professional network 102, screening system 102 allows the moderators to leverage a vast network of professionals in conducting the interviews instead of a much smaller set of employees from the same company or organization.

As shown in FIG. 1, interviewers 110 and candidates 116 (e.g., job candidates) participating in the interviews may be identified by an identification mechanism 108 using data from data repository 134 and/or online professional network 118. First, identification mechanism 108 may identify candidates 116 as users who have applied to jobs, positions, roles, and/or opportunities, within or outside online professional network 118. Identification mechanism 108 may also, or instead, identify candidates 116 as users and/or members of online professional network 118 with skills, work experience, and/or other attributes or qualifications that match the corresponding jobs, positions, roles, and/or opportunities.

Second, identification mechanism 108 may identify interviewers 110 as members of online professional network 118 and/or other users who have registered with screening system 102 to conduct interviews. Interviewers 110 may additionally or alternatively include users that are identified by identification mechanism 108 as having skills, experience, reputations, recommendations, and/or other qualifications for conducting interviews for the corresponding jobs, positions, roles, and/or opportunities.

Identification mechanism 108 and/or another component of the system may also include functionality to obtain user input for specifying interviewers 110, candidates 116, and/or other entities participating in interviews managed through screening system 102. For example, the component may include a user interface that allows a recruiter, sourcer, human resources professional, and/or other moderator involved in screening for and/or placing jobs, positions, roles, and/or opportunities to select one or more candidates 116, interviewers 110, and/or interviews for the jobs, positions, roles, and/or opportunities.

In one or more embodiments, screening system 102 uses online professional network 118 data to match interviewers 110 to interviews with candidates 116. As described in further detail below, screening system 102 may use profile and/or activity data with online professional network 118 to identify interviewers 110 that are qualified, available, reputable, and/or otherwise suitable for conducting the corresponding interviews. Screening system 102 may further include tools and/or services for suggesting questions to ask during the interviews, scheduling the interviews, facilitating collaboration and/or interaction between interviewers 110 and candidates 116 during the interviews, and/or obtaining feedback from interviewers 110 and candidates 116 after the interviews. Consequently, screening system 102 may increase the availability and/or quality of interviewers 110 and/or interviews for opportunities associated with companies or organizations of various sizes and streamline the screening process for moderators, interviewers 110, candidates 116, and/or other entities affected by the interviews.

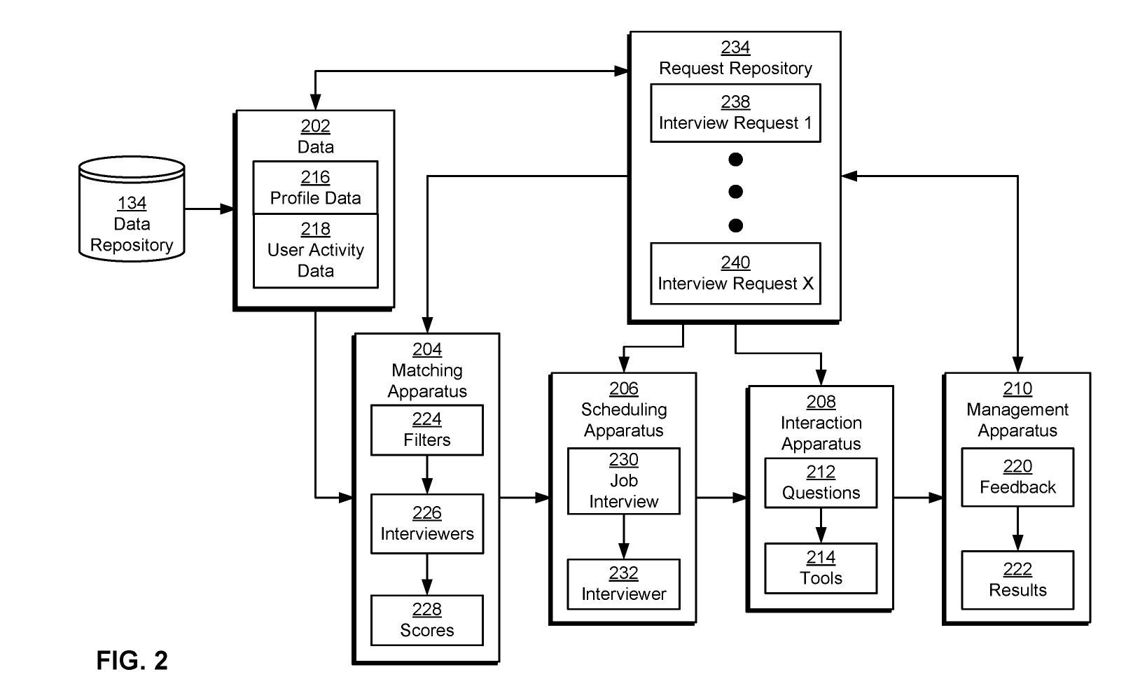

FIG. 2 shows a system for processing data in accordance with the disclosed embodiments. More specifically, FIG. 2 shows a system for performing automated distributed screening of candidates, such as screening system 102 of FIG. 1. The system includes a matching apparatus 204, a scheduling apparatus 206, an interaction apparatus 208, and a management apparatus 210. Each of these components is described in further detail below.

As shown in FIG. 2, the system utilizes data 202 from data repository 134, which includes profile data 216 for members of a social network or other community of users (e.g., online professional network 118 of FIG. 1), as well as user activity data 218 that tracks the members' activity within and/or outside the social network. Profile data 216 may include data associated with member profiles in the social network. For example, profile data 216 for an online professional network may include a set of attributes for each user, such as demographic (e.g., gender, age range, nationality, location, language), professional (e.g., job title, professional summary, professional headline, employer, industry, experience, skills, seniority level, professional endorsements), social (e.g., organizations to which the user belongs, geographic area of residence), and/or educational (e.g., degree, university attended, certifications, licenses) attributes. Profile data 216 may also include a set of groups to which the user belongs, the user's contacts and/or connections, patents or publications associated with the user, and/or other data related to the user's interaction with the social network.

Attributes of the members may be matched to a number of member segments, with each member segment containing a group of members that share one or more common attributes. For example, member segments in the social network may be defined to include members with the same industry, title, location, and/or language.

Connection information in profile data 216 may additionally be combined into a graph, with nodes in the graph representing entities (e.g., users, schools, companies, locations, etc.) in the social network. In turn, edges between the nodes in the graph may represent relationships between the corresponding entities, such as connections between pairs of members, education of members at schools, employment of members at companies, following of a member or company by another member, business relationships and/or partnerships between organizations, and/or residence of members at locations.

User activity data 218 may include records of member interactions with one another and/or content associated with the social network. For example, user activity data 218 may be used to track impressions, clicks, likes, dislikes, shares, hides, comments, posts, updates, conversions, and/or other user interaction with content in the social network. User activity data 218 may also, or instead, track other types of social network activity, including connections, messages, job applications, and/or interaction with groups or events. User activity data 218 may further include social validations of skills, seniorities, job titles, and/or other profile attributes, such as endorsements, recommendations, ratings, reviews, collaborations, discussions, articles, posts, comments, shares, and/or other member-to-member interactions that are relevant to the profile attributes. User activity data 218 may further include schedules, calendars, and/or upcoming availability of the users, which may be used to schedule meetings, interviews, and/or events for the users. Like profile data 216, user activity data 218 may be used to create a graph, with nodes in the graph representing social network members and/or content and edges between pairs of nodes indicating actions taken by members, such as creating or sharing articles or posts, sending messages, sending or accepting connection requests, endorsing or recommending one another, writing reviews, applying to opportunities, joining groups, and/or following other entities.

Profile data 216, user activity data 218, and/or other data in data repository 134 may be standardized before the data is used by components of the system. For example, skills in profile data 216 may be organized into a hierarchical taxonomy that is stored in data repository 134 and/or another repository. The taxonomy may model relationships between skills (e.g., “Java programming” is related to or a subset of “software engineering”) and/or standardize identical or highly related skills (e.g., “Java programming,” “Java development,” “Android development,” and “Java programming language” are standardized to “Java”).

In one or more embodiments, the system of FIG. 2 uses profile data 216 and/or user activity data 218 to automatically select an interviewer 232 for a job interview 230. Job interview 230 may be conducted in response to an interview request (e.g., interview request 1 238, interview request x 240) from a recruiter, hiring manager, and/or other “moderator” involved in hiring or placing candidates for various jobs, roles, positions, and/or opportunities. For example, each interview request may be generated by a moderator through a user interface provided by the system. The interview request may include a job title, job description, skills, experience, and/or other characteristics of a job to be filled. The interview request may additionally include attributes associated with one or more interviews to be conducted with candidates for the job, such as a budget for the interview(s), a time period, the number of interviews, the duration of each interview, the type of the interview (e.g., phone screen, onsite interview, technical interview, non-technical interview, audition, etc.), and/or conflicts of interest associated with the interview(s) (e.g., employment of an interviewer at a company that is a direct competitor with the company for which job interview 230 is to be conducted). After the interview request is submitted, the interview request may be stored in request repository 234, which may include a relational database, distributed filesystem, data warehouse, cloud storage, and/or other data-storage mechanism.

After a given interview request is received in request repository 234 and/or by the system, matching apparatus 204 selects one or more potential interviewers 226 as matches for each job interview 230 associated with an interview request in request repository 234. First, matching apparatus 204 applies one or more filters 224 associated with attributes of the interview request to profile data 216 and/or user activity data 218 to identify interviewers 226. For example, matching apparatus 204 may filter interviewers 226 to include online professional network members with availability that matches the time period and/or time slots in the interview request. In another example, matching apparatus 204 may filter interviewers 226 to remove members that are directly connected to the candidate in the social network and/or that have conflicts of interest with the interview request and/or entity from which the interview request was received.

Next, matching apparatus 204 generates a set of scores 228 for interviewers 226 that pass filters 224. Scores 228 may represent the extent to which each interviewer “matches” or is suitable for conducting job interview 230. For example, a score for the interviewer may reflect the interviewer's reputation, past interviewing performance, and/or familiarity or experience with the skills, work experience, role, and/or other attributes of the job or opportunity. A higher score may represent a higher match between the interviewer and the interviewer request, and a lower score may represent a lower match between the interviewer and the interview request.

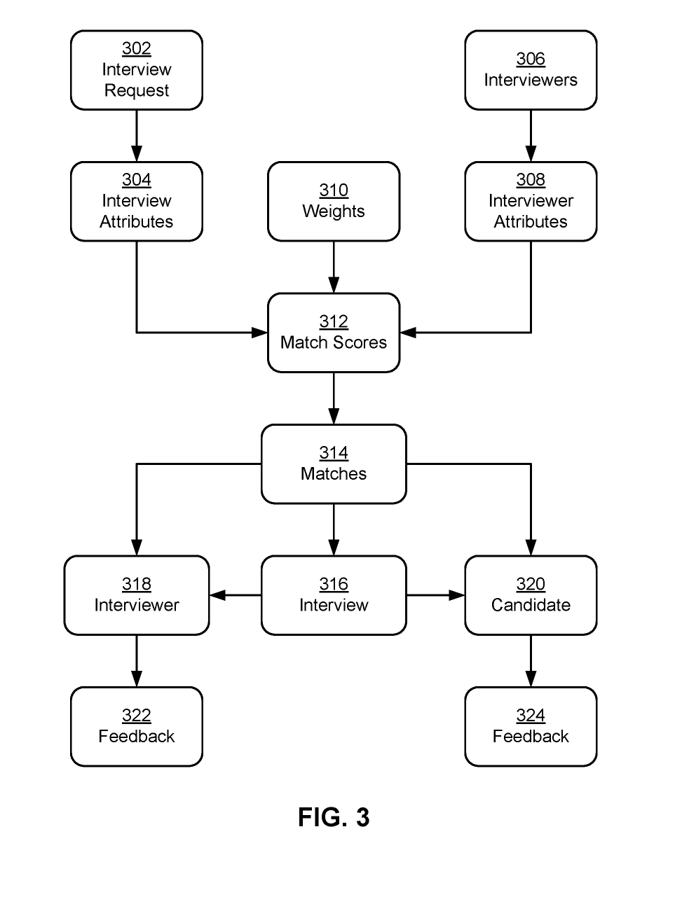

After scores 228 are calculated for interviewers 226, scheduling apparatus 206 schedules a job interview 230 between the candidate and a given interviewer 232 from interviewers 226. Interviewer 232 may be selected from interviewers 226 based on scores 228 and/or availability. For example, interviewer 232 may be the first interviewer in a list of interviewers 226 ordered by decreasing score that accepts an invitation to conduct job interview 230. The invitation may include one or more available time slots and/or a location for job interview 230. Automatically selecting interviewers for job interviews is described in further detail below with respect to FIG. 3.

To help the selected interviewer 232 conduct job interview 230, interaction apparatus 208 provides a set of suggested questions 212 to interviewer 232. For example, interaction apparatus 208 may obtain questions 212 from data repository 134, request repository 234, and/or another data store. Interaction apparatus 208 may filter questions 212 by tags representing skills and/or other attributes of the job. Interaction apparatus 208 may also, or instead, calculate a score for each question based on the number of times the question has previously been asked, the familiarity of interviewer 232 with the question, prior usage of the question by interviewer 232 and/or other interviewers, the candidate's previous exposure to the question, the quality or relevance of the question, ratings of the question by other interviewers, and/or other factors. Interaction apparatus 208 may then order questions 212 by descending order of score and select a subset of the highest scored questions and/or questions 212 with scores that exceed a threshold as suggestions that are presented to interviewer 232 before and/or during job interview 230.

Interaction apparatus 208 further includes a set of tools 214 for enabling or facilitating interaction or collaboration between interviewer 232 and the candidate during job interview 230. For example, interaction apparatus 208 may include tools 214 for conducting teleconferences, video conferences, and/or text-based chats; recording audio and/or video; writing, compiling, and/or running code; and/or obtaining and saving text-based input, drawings, and/or audio recordings. Input obtained by or through tools 214 during job interview 230 may be stored in a repository for subsequent review by the moderator and/or other entities involved in the screening process.

After job interview 230 is complete, management apparatus 210 obtains feedback 220 for job interview 230 from interviewer 232, the candidate, the moderator, and/or other entities involved in the screening process. For example, management apparatus 210 may include a user interface that allows interviewer 232 to enter a rating, review, and/or other feedback 220 related to the performance of the candidate. The user interface may also allow interviewer 232 to specify one or more questions 212 asked during job interview 230, rate and/or review questions 212, and/or submit content generated during job interview 230 (e.g., chat transcripts, audio, video, images, code, documents, etc.). In another example, management apparatus 210 may allow the candidate to rate and/or review the professionalism, politeness, patience, respectfulness, and/or other attributes of interviewer 232. In a third example, management apparatus 210 may include a user interface and/or mechanism that allows the moderator and/or creator of the original interview request to rate and/or review interviewer 232 based on the quality of the candidate in subsequent interview rounds and/or other outcomes related to job interview 230.

By leveraging professional network data to automatically arrange and/or manage job interviews, the system of FIG. 2 may allow recruiters, sourcers, managers, and/or other moderators of screening processes to access potential interviewers 226 and/or interview resources (e.g., questions 212, tools 214, feedback 220, etc.) outside of their networks and/or organizations, reduce manual overhead associated with selecting interviewers and/or lining up interviews, and ensure that interviewers 226 matched to the job interviews have the requisite skills, experience, and/or background to assess the corresponding candidates. At the same time, feedback 220 from multiple parties involved in the screening process and the ability to review conversations, content, and/or interaction from the job interviews may improve the quality of the interviews, interviewers 226, and/or screening process. Consequently, the system may improve computer technologies related to recruiting, screening, scheduling, matching, and/or online networks, as well as user engagement, user experiences, and user interaction through the technologies and/or network-enabled devices or applications used to access the technologies.

Those skilled in the art will appreciate that the system of FIG. 2 may be implemented in a variety of ways. First, matching apparatus 204, scheduling apparatus 206, interaction apparatus 208, management apparatus 210, data repository 134, and request repository 234 may be provided by a single physical machine, multiple computer systems, one or more virtual machines, a grid, one or more databases, one or more filesystems, and/or a cloud computing system. Matching apparatus 204, scheduling apparatus 206, interaction apparatus 208, and management apparatus 210 may additionally be implemented together and/or separately by one or more hardware and/or software components and/or layers.

Second, the system of FIG. 2 may be adapted to various types of interviews, screenings, and/or interactions. For example, the functionality of the system may be used with interviews, screenings, auditions, and/or other types of interactions with applicants or candidates for academic positions, artistic or musical roles, school admissions, fellowships, scholarships, competitions, club or group memberships, matchmaking, and/or other types of opportunities.

FIG. 3 shows the automated distributed screening of a candidate 320 in accordance with the disclosed embodiments. As mentioned above, candidate 320 may be an entity under consideration for a job, position, role, and/or other opportunity. For example, candidate 320 may be an applicant, nominee, and/or entrant that is being considered for a particular opportunity. As a result, the qualifications and/or suitability of candidate 320 for the opportunity may be assessed in an interview 316 such as a phone screen, onsite interview, and/or other type of interaction with an interviewer 318.

Interview 316 may be scheduled, initiated, and/or conducted in response to an interview request 302 from a moderator associated with the opportunity and/or screening process for the opportunity. For example, interview request 302 may be submitted by a recruiter, hiring manager, human resources professional, executive, coordinator, and/or other entity involved in filling a job or position at a company, school, group, and/or organization. To generate interview request 302, the entity may submit interview attributes 304 associated with interview request 302 through a user interface provided by an application (e.g., web application, native application, mobile application, etc.) and/or over email, phone, text, messaging, and/or another communications mechanism.

Interview attributes 304 include parameters and/or constraints associated with interview 316. For example, interview attributes 304 may identify candidate 320, the position or opportunity for which interview 316 is used to screen candidate 320, a time period within which interview 316 is to be conducted (e.g., the next two weeks, the next month, etc.), a number of interviews to be conducted over that period, a budget for each interview or all interviews, and/or the type of each interview (e.g., phone screen, teleconference, onsite, technical, non-technical, etc.). Interview attributes 304 may also, or instead, include skills, work experience, education, and/or other requirements or qualifications to be tested during interview 316.

Some interview attributes 304 may be automatically retrieved based on other interview attributes 304. For example, the creator of interview request 302 may include a link to a job listing in interview attributes 304. In turn, the job listing may be parsed to obtain a job title, industry, seniority, minimum work experience, education, skills, and/or other interview attributes 304 associated with interview request 302.

After interview request 302 is received, interview attributes 304 are matched to interviewer attributes 308 of a set of potential interviewers 306 to identify a subset of interviewers 306 as matches 314 for interview request 302. Interviewers 306 may include members of an online professional network (e.g., online professional network 118 of FIG. 1) and/or other users who have registered as interviewers with a screening system, such as the system of FIG. 2. Interviewer attributes 308 may thus be obtained from interviewers 306 during registration and/or from profiles of interviewers 306 with the online professional network.

Interviewers 306 may also, or instead, include users who are identified as qualified for conducting certain types of interviews by the screening system. As a result, interviewer attributes 308 may be obtained from online professional network profiles of the users; resumes of the users; public records; recommendations, endorsements, or other social validation of the users; and/or reviews or ratings of the users' historical performance as interviewers 306.

More specifically, interviewer attributes 308 include data that is used to assess the qualifications and/or suitability of interviewers 306 in conducting interview 316. Interviewer attributes 308 may thus include employment, work experience, seniority, industry, title, education, skills, endorsements, recommendations, certifications, licenses, awards, accomplishments, and/or other self-reported and/or socially validated professional qualifications of interviewers 306. Interviewer attributes 308 may also include online professional network connections, schedules, and/or calendars of interviewers 306 and/or the amounts charged by interviewers 306 for various types and/or durations of interviews.

Interview attributes 304 and interviewer attributes 308 may be used to filter interviewers 306 so that matches 314 include only interviewers 306 that are qualified to conduct interview 316 and adhere to constraints specified in interview request 302. For example, interviewers 306 may be filtered to remove users with qualifications that do not overlap with those specified in interview request 302, users who are within a certain network distance from candidate 320 (e.g., within three hops in a social network), users that have a particular type of connection with candidate 320 (e.g., follower, member of a common group), users that lack a certain amount of experience in the industry or domain associated with the opportunity, users that lack availability within the time period or deadline specified in interview request 302, and/or users that charge more than the budget specified in interview request 302.

Next, interview attributes 304 are combined with interviewer attributes 308 and a set of weights 310 to calculate a set of match scores 312 between interviewers 306 that pass the filters and interview request 302. Each match score may represent the extent to which interviewer attributes 308 for a given interviewer match interview attributes 304 for interview request 302. Thus, a higher match score may represent a better match between the interviewer and interview request 302, and a lower match score may represent a less ideal match between the interviewer and interview request 302.

For example, each match score may include a sub-score representing the extent to which interviewer attributes 308 establish the corresponding interviewer as qualified or suitable for conducting interview 316. Thus, the sub-scores may reflect the overlap between the interviewer's title, industry, skills, experience, education, certifications, licenses, and/or other qualifications and those specified in interview attributes 304; endorsements, recommendations, reputation scores, and/or other social or external validation of the interviewer's qualifications; the difference in experience between the interviewer and candidate 320; the interviewer's performance in conducting interviews (e.g., based on reviews, ratings, and/or other performance metrics with past interviews conducted by the interviewer); the interviewer's pay rate; and/or overlap in the schedules and/or availabilities of the interviewer and candidate 320.

Weights 310 for the sub-scores may reflect the relative importance of the corresponding dimensions and/or categories in assessing the suitability of the interviewer for conducting interview 316. Continuing with the example, a reputation model and/or other statistical model or machine learning technique may be used to generate and/or update weights 310 associated with ratings, reviews, endorsements, recommendations, reputation scores, availability, pricing, and/or other interviewer attributes 304 used to calculate a match score for the interviewer. Weights 310 may be adjusted and/or tuned to reflect outcomes from previous interviews, feedback related to the interviewer and/or other interviewers, and/or the distribution or frequency of certain interviewer attributes 304 (e.g. ratings, scores, etc.). Weights 310 may further be scaled so that the final match score falls within a range of values (e.g., between 0 and 1).

After match scores 312 are calculated between potential interviewers 306 and interview request 302, match scores 312 are used to identify one or more interviewers 306 as matches 314 for interview request 302, and interview 316 is scheduled between candidate 320 and an interviewer 318 in matches 314. For example, interviewers 306 may be ranked by descending match score, and a certain number of interviewers 306 with the highest match scores 312 (e.g., interviewers 306 with the three highest match scores 312) and/or a subset of interviewers 306 with match scores 312 that exceed a numeric or percentile threshold may be obtained as matches 314. In turn, one or more time slots that are compatible with the schedules of both candidate 320 and the highest ranked interviewer (e.g., interviewer 318) in matches 314 may be identified, and an invitation to conduct interview 316 at the selected time slot(s) may be sent to the interviewer. If the interviewer accepts the invitation, interview 318 may be conducted at the scheduled time. If the interviewer rejects the invitation, a new interview time may be selected between the next-highest-ranked interviewer in matches 314 and candidate 320, and an invitation may be sent to the next interviewer. The process may repeat until an invitation for interview 318 is accepted by an interviewer in matches 314.

After interview 316 is successfully scheduled between candidate 320 and a given interviewer 318, interviewer 318 may conduct interview 316 using a set of suggested questions (e.g., questions 212 of FIG. 2) and/or collaboration tools (e.g., tools 214 of FIG. 2). At the conclusion of interview 316, interviewer 318 may provide feedback 322 on candidate 320 and/or other aspects of interview 316, and candidate 320 may provide feedback 322 on interviewer 318 and/or other aspects of interview 316. For example, interviewer 318 may rate and/or review candidate 320 with respect to answers provided by candidate 320 to questions from interviewer 318, code and/or content generated by candidate 320, qualifications related to the opportunity for which candidate 320 is interviewing, and/or other aspects of interaction with candidate 320. Candidate 320 may rate and/or review interviewer 318 with respect to professionalism, respect, courtesy, patience, and/or other interviewer attributes 308. Interviewer 318 and/or candidate 320 may also rate and/or review the suitability of interviewer 318 in conducting interview 316, questions suggested and/or asked during interview 316, tools used to facilitate interaction during interview 316, and/or other aspects of the scheduling, management, and/or resources associated with interview 316.

Feedback 322-324 may then be provided to the moderator, used to update interviewer attributes 308 for interviewer 318, and/or used to determine an outcome of interview 316. For example, the moderator may review feedback 322-324 from interviewer 318 and candidate 320 to assess the performance of interviewer 318 in interviewing candidate 320 and/or the qualifications of candidate 320 for the opportunity. The moderator may also use feedback 322-324 and/or records of interaction during interview 316 to provide additional feedback for rating and/or reviewing the performance of interviewer 318 and/or candidate 320. The moderator may further use feedback 322-324 to advance candidate 320 to subsequent rounds of screening, extend an offer related to the opportunity, accept candidate 320 for the opportunity, and/or reject candidate 320 for the opportunity. Finally, interviewer attributes 308 for interviewer 318 may be updated to reflect feedback 324 from candidate 320 and/or additional feedback from the moderator. In turn, the updated interviewer attributes 308 may be used in matching of interviewer 318 to subsequent interview requests.

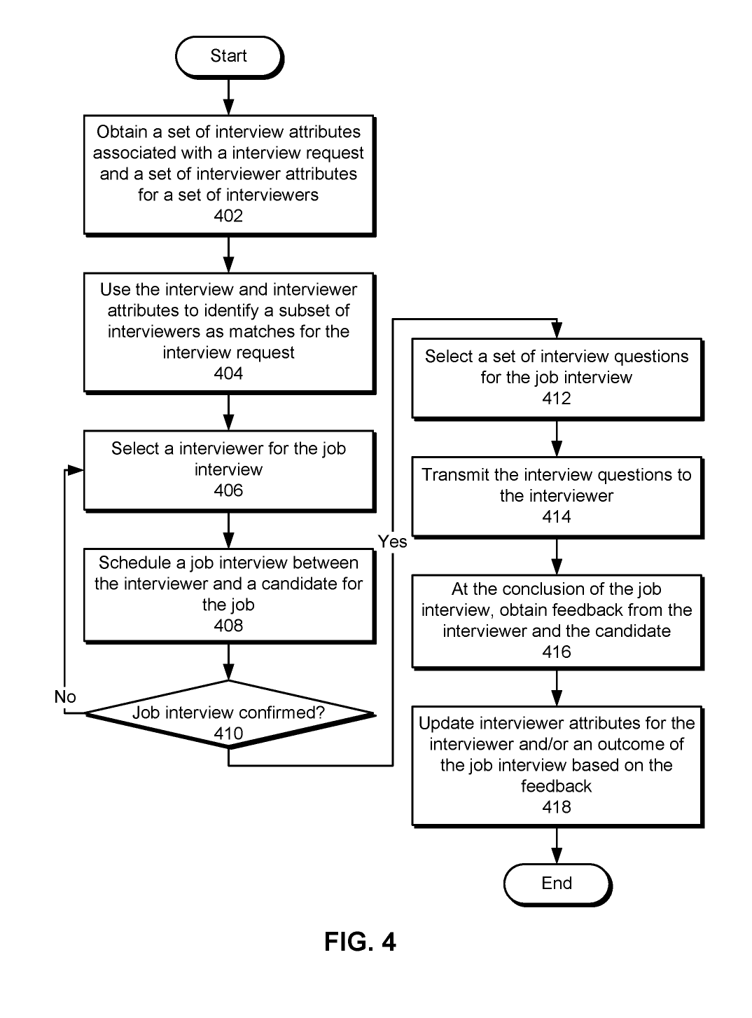

FIG. 4 shows a flowchart illustrating the processing of data in accordance with the disclosed embodiments. In one or more embodiments, one or more of the steps may be omitted, repeated, and/or performed in a different order. Accordingly, the specific arrangement of steps shown in FIG. 4 should not be construed as limiting the scope of the embodiments.

Initially, a set of interview attributes associated with an interview request and a set of interviewer attributes for a set of interviewers are obtained (operation 402). The interview attributes may include a time period and/or deadline within which an interview is to be conducted, a budget for the interview, a type of the interview (e.g., in-person, phone screen, technical, non-technical, audition, etc.), a candidate to be interviewed, and/or an opportunity for which the interview is conducted (e.g., job, position, role, scholarship, fellowship, school admissions, security clearance, group membership, etc.). The interview attributes may also include skills, experience, education, and/or other criteria or qualifications associated with the opportunity. The interviewer attributes may include desired qualifications of interviewers for the opportunity; social validations and/or measures of expertise in the qualifications (e.g., recommendations, endorsements, reputation scores, etc.); pay rates, schedules and/or availability; and/or ratings, reviews, and/or other performance metrics associated with the interviewers.

Next, the interview and interviewer attributes are used to identify a subset of interviewers as matches for the interview request (operation 404). In particular, one or more interview attributes may be used as filters for the interviewer attributes to ensure that the matches include only qualified, available, and/or compatible interviewers. For example, the filters may be used to remove interviewers that charge more than the budget for the interview, cannot conduct the interview before the deadline, have existing relationships with the candidate, have conflicts of interest with the opportunity and/or candidate, and/or have qualifications (e.g., skills, experience, education, etc.) that do not overlap with or meet those specified in the interview attributes.

After the filters are applied, the interview attributes and interviewer attributes are used to calculate a set of match scores between the set of the interviewers and the interview request. For example, a set of sub-scores may be calculated for each interviewer to reflect the strength of the interviewer's qualifications, availability, pay, past interview performance, and/or other attributes with respect to the corresponding interview attributes. The sub-scores may then be combined with a set of weights into a single match score between the interviewer and the interview request. The weights may be selected and/or tuned to reflect historical outcomes, the accuracy of previous matches, and/or other data or outcomes associated with past interviews. Finally, matches for the interview request may be selected as a subset of interviewers with the highest match scores.

Once the matches are identified, an interviewer is selected from the matches (operation 406), and a job interview is scheduled between the interviewer and the candidate (operation 408). Operations 406-408 may be repeated until the job interview is confirmed (operation 410) by the interviewer and/or candidate. For example, the matches may be ranked in descending order of match score, and a job interview may be scheduled with the highest ranked interviewer according to the schedules of the interviewer and candidate. If an invitation for the job interview is accepted by the interviewer, scheduling of the job interview may be complete. If the invitation is rejected by the interviewer, one or more additional invitations may be sequentially sent to remaining matches in decreasing order of match score until an invitation is accepted. In other words, the job interview may be scheduled with an interviewer with the highest possible match score who is also available and willing to conduct the interview within the specified time frame.

A set of interview questions for the job interview is then selected (operation 412) and transmitted to the interviewer (operation 414). For example, the interview questions may be selected to include questions asked in previous and/or similar interviews, questions with which the interviewer is familiar, highly rated questions, questions that have not been asked of the candidate, and/or questions that are tagged with and/or matched to skills or qualifications identified in the interview request. The interview questions may be provided as suggestions to the interviewer to assist the interviewer with conducting the interview. The interviewer may then use the questions and/or collaboration tools (e.g., tools for videoconferencing, writing code, generating content, etc.) to conduct the interview at the scheduled time.

At the conclusion of the job interview, feedback is obtained from both the interviewer and the candidate (operation 416), and interviewer attributes for the interviewer and/or an outcome of the job interview are updated based on the feedback (operation 418). For example, the interviewer and/or candidate may provide feedback related to one another, tools and/or questions used in the interview, and/or the matching of the interviewer to the opportunity or interview. The feedback may include ratings, reviews, and/or other forms of user input. In turn, the feedback may be used to update a reputation score and/or other performance metrics for the interviewer and/or determine if the candidate is to advance in the screening process and/or be dropped from consideration for the opportunity.

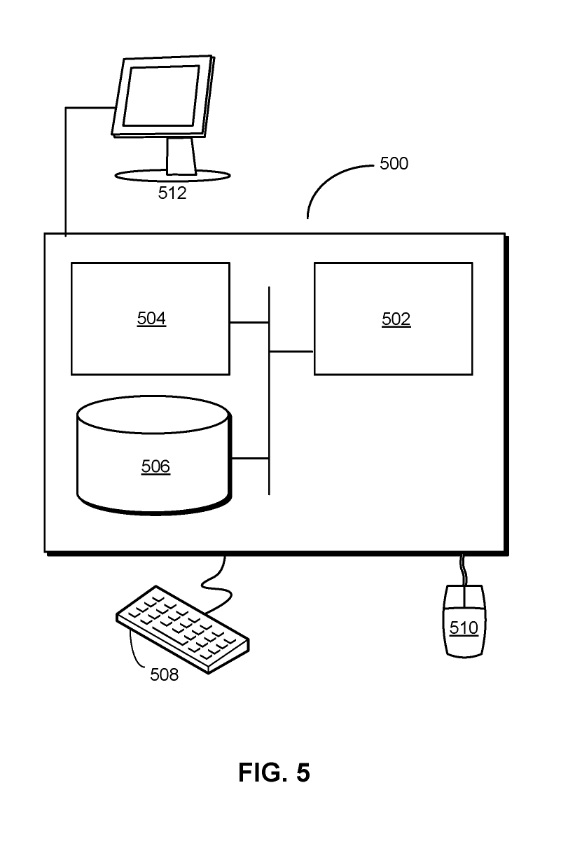

FIG. 5 shows a computer system 500 in accordance with the disclosed embodiments. Computer system 500 includes a processor 502, memory 504, storage 506, and/or other components found in electronic computing devices. Processor 502 may support parallel processing and/or multi-threaded operation with other processors in computer system 500. Computer system 500 may also include input/output (I/O) devices such as a keyboard 508, a mouse 510, and a display 512.

Computer system 500 may include functionality to execute various components of the present embodiments. In particular, computer system 500 may include an operating system (not shown) that coordinates the use of hardware and software resources on computer system 500, as well as one or more applications that perform specialized tasks for the user. To perform tasks for the user, applications may obtain the use of hardware resources on computer system 500 from the operating system, as well as interact with the user through a hardware and/or software framework provided by the operating system.

In one or more embodiments, computer system 500 provides a system for processing data. The system includes a matching apparatus, a scheduling apparatus, and a management apparatus, one or more of which may alternatively be termed or implemented as a module, mechanism, or other type of system component. The matching apparatus may obtain a set of interview attributes associated with an interview request and a set of interviewer attributes for a set of interviewers. The interview attributes may include a skill set for a job, a timeline, and/or a budget, and the interviewer attributes may include a level of expertise in a skill (e.g., as determined by reputation score, endorsements, recommendations, and/or other validation of the skill). Next, the matching apparatus may use the set of interview attributes and the set of interviewer attributes to identify a subset of the interviewers as matches for the interview request. The scheduling apparatus may then schedule a job interview between an interviewer in the subset of interviewers and a candidate for the job. At a conclusion of the job interview, the management apparatus may obtain feedback for the job interview from the interviewer and the candidate.

In addition, one or more components of computer system 500 may be remotely located and connected to the other components over a network. Portions of the present embodiments (e.g., matching apparatus, scheduling apparatus, interaction apparatus, management apparatus, data repository, request repository, etc.) may also be located on different nodes of a distributed system that implements the embodiments. For example, the present embodiments may be implemented using a cloud computing system that manages, schedules, and/or facilitates screening of candidates by a set of remote interviewers.

By configuring privacy controls or settings as they desire, members of a social network, a professional network, or other user community that may use or interact with embodiments described herein can control or restrict the information that is collected from them, the information that is provided to them, their interactions with such information and with other members, and/or how such information used. Implementation of these embodiments is not intended to supersede or interfere with the members' privacy settings.

The foregoing descriptions of various embodiments have been presented only for purposes of illustration and description. They are not intended to be exhaustive or to limit the present invention to the forms disclosed. Accordingly, many modifications and variations will be apparent to practitioners skilled in the art. Additionally, the above disclosure is not intended to limit the present invention.

What is claimed is:

1. A method, comprising:
obtaining a set of interview attributes associated with an interview request, wherein the set of interview attributes comprises a skill set for a job, a timeline, and a budget;
obtaining a set of interviewer attributes for a set of interviewers, wherein the set of interviewer attributes comprises a level of expertise in a skill;
using the set of interview attributes and the set of interviewer attributes to identify, by a computer system, a subset of the interviewers as matches for the interview request;
scheduling, by the computer system, a job interview between an interviewer in the subset of interviewers and a candidate for the job; and
at a conclusion of the job interview, obtaining feedback for the job interview from one or more of the interviewer and the candidate.

2. The method of claim 1, further comprising:
updating a subset of the interviewer attributes for the interviewer based on a subset of the feedback from the candidate and additional feedback from a sender of the interview request.

3. The method of claim 2, wherein the updated subset of the interviewer attributes comprises a reputation score for the interviewer.

4. The method of claim 1, further comprising:
selecting a set of interview questions for the job interview based on one or more of the interview attributes; and
transmitting the set of interview questions to the interviewer.

5. The method of claim 4, wherein selecting the set of interview questions for the job interview based on the one or more of the interview attributes comprises at least one of:
matching an interview question to a skill in the skill set; and
including the interview question in the set of interview questions based on prior usage of the interview question in previous job interviews.

6. The method of claim 1, further comprising:
selecting the interviewer for the job interview from the subset of interviewers prior to scheduling the job interview.

7. The method of claim 6, wherein selecting the interviewer comprises at least one of:
selecting the interviewer that best matches the set of interview attributes; and
verifying an availability of the interviewer.

8. The method of claim 1, wherein using the set of interview attributes and the set of interviewer attributes to identify the subset of the interviewers as matches for the interview request comprises:
applying a filter from the interview attributes to the set of interviewer attributes.

9. The method of claim 8, wherein the filter is at least one of:
a budget constraint;
an availability constraint; and
a qualification.

10. The method of claim 1, wherein using the set of interview attributes and the set of interviewer attributes to identify the subset of the interviewers as matches for the interview request comprises:
using the set of interview attributes and the set of interviewer attributes to calculate a set of match scores between the set of the interviewers and the interview request; and
selecting the subset of the interviewers with a highest subset of the match scores.

11. The method of claim 10, wherein the set of match scores is calculated using a set of weights associated with the set of interviewer attributes and the set of interview attributes.

12. The method of claim 1, wherein the feedback comprises at least one of:
a review; and
a rating.

13. A system, comprising:
one or more processors; and
memory storing instructions that, when executed by the one or more processors, cause the system to:
obtain a set of interview attributes associated with an interview request, wherein the set of interview attributes comprises a skill set for a job, a timeline, and a budget;
obtain a set of interviewer attributes for a set of interviewers, wherein the set of interviewer attributes comprises a level of expertise in a skill;
use the set of interview attributes and the set of interviewer attributes to identify a subset of the interviewers as matches for the interview request;
schedule a job interview between an interviewer in the subset of interviewers and a candidate for the job; and
at a conclusion of the job interview, obtain feedback for the job interview from one or more of the interviewer and the candidate.

14. The system of claim 13, wherein the memory further stores instructions that, when executed by the one or more processors, cause the system to:
select a set of interview questions for the job interview based on one or more of the interview attributes; and
transmit the set of interview questions to the interviewer.

15. The system of claim 14, wherein selecting the set of interview questions for the job interview based on the one or more of the interview attributes comprises at least one of:
matching an interview question to a skill in the skill set; and
including the interview question in the set of interview questions based on prior usage of the interview question in previous job interviews.

16. The system of claim 13, wherein the memory further stores instructions that, when executed by the one or more processors, cause the system to:
select the interviewer for the job interview from the subset of interviewers prior to scheduling the job interview.

17. The system of claim 16, wherein selecting the interviewer comprises at least one of:
selecting the interviewer that best matches the set of interview attributes; and
verifying an availability of the interviewer.

18. The system of claim 13, wherein using the set of interview attributes and the set of interviewer attributes to identify the subset of the interviewers as matches for the interview request comprises at least one of:
applying a filter from the interview attributes to the set of interviewer attributes;
using the set of interview attributes and the set of interviewer attributes to calculate a set of match scores between the set of the interviewers and the interview request; and
selecting the subset of the interviewers with a highest subset of the match scores.

19. A non-transitory computer-readable storage medium storing instructions that when executed by a computer cause the computer to perform a method, the method comprising:
obtaining a set of interview attributes associated with an interview request, wherein the set of interview attributes comprises a skill set for a job, a timeline, and a budget;
obtaining a set of interviewer attributes for a set of interviewers, wherein the set of interviewer attributes comprises a level of expertise in a skill;
using the set of interview attributes and the set of interviewer attributes to identify a subset of the interviewers as matches for the interview request;
scheduling a job interview between an interviewer in the subset of interviewers and a candidate for the job; and
at a conclusion of the job interview, obtaining feedback for the job interview from the interviewer and the candidate.

20. The non-transitory computer-readable storage medium of claim 19, wherein using the set of interview attributes and the set of interviewer attributes to identify the subset of the interviewers as matches for the interview request comprises at least one of:
applying a filter from the interview attributes to the set of interviewer attributes;
using the set of interview attributes and the set of interviewer attributes to calculate a set of match scores between the set of the interviewers and the interview request; and
selecting the subset of the interviewers with a highest subset of the match scores.
